(19) United States
(12) Patent Application Publication
(10) Pub. No.: US 2002/0100053 A1
(43) Pub. Date: Jul. 25, 2002

(54) Semiconductor processing video monitoring system

(76) Inventors: Tue Nguyen, Fremont, CA (US); Tai Dung Nguyen, Fremont, CA (US)

Correspondence Address: Tue Nguyen, 496 Olive Ave., Fremont, CA, 94539, US

(21) Appl. No.: 09/765,821

(22) Filed: Jan. 19, 2001

(51) Int. Cl. H04N 7/173; H04N 7/18

(52) U.S. Cl. 725/105; 348/82; 348/207

(57) ABSTRACT

A system captures one or more images of a process chamber having a view port. The system includes a radiation source to generate radiation; and a camera coupled to the process chamber and adapted to receive the radiation from the radiation source illuminating the process chamber.

### BACKGROUND

This invention relates to apparatus and methods to monitor the processing of substrates.

In many semiconductor-manufacturing processes, substrates are processed in a series of one or more phases. For example, substrates can undergo a pre-heating phase during which the substrate is heated to an initial temperature before the substrate is loaded completely into a processing chamber and processed with a prescribed heating cycle. To achieve the required device performance, yield, and process repeatability, the processing of a substrate such as a semiconductor wafer is strictly controlled inside a process chamber.

Generally, a process chamber has a chamber body enclosing components of the process chamber. The process chamber typically maintains vacuum and provides a sealed environment for process gases during substrate processing. Conventional equipment typically uses one or more sensors to detect out-of-range conditions and other conditions. These sensors are typically based on beams of light, but they can be mechanical sensors such as contact switches as well. These sensors can be used to generate warnings to operators to clean or replace or fix certain problems inside the chamber. On these occasions as well as when the process chamber needs to be periodically accessed to cleanse the chamber and to remove unwanted materials cumulating in the chamber, the operator needs to access the interior of the chamber. To support maintenance for the process chamber, an opening is typically provided at the top of the process chamber that is sufficiently large to provide access to the internal components of the process chamber. To support these conflicting requirements, a lid is used to help the process chamber to provide a sealed environment for the processing gases during substrate processing by mating with the process chamber and incorporating an elastomeric seal between the lid and the process chamber, and to allow access to the inner chamber. Typically, a lid provides access to the components inside the chamber, and shields the operator from exposure to high temperatures during system operation. The lid generally remains closed during most process steps unless the chamber is opened, for example, to perform a preventive maintenance chamber cleaning, thereby breaking the vacuum and bringing the chamber to atmospheric pressure.

A common problem associated with the processing of semiconductor wafers is the inability to remotely monitor wafer movement and process condition. This ability is useful in observing, detecting and correcting problems as they occur. Since it is desirable to have assistance from manufacturer's representatives and field personnel for complex repair operations, and yet since experts from the manufacturer may not be local to the operator, a need exists for remote monitoring of wafer processing operations. Additionally, even if the expert is local, it can be cost prohibitive to employ an expert to constantly monitor the equipment and wait for the occurrence of particular problematic processing steps.

### SUMMARY

In one aspect, a system to capture one or more images of a semiconductor chamber includes a radiation source to generate radiation to illuminate the chamber; and a camera coupled to the process chamber and adapted to receive the radiation reflected from the chamber.

Implementations of the above aspect may include one or more of the following. The radiation source can be one or more lamps. A processor can be connected to the camera. A data storage device can also be connected to the processor and the camera to store images from the camera. A network adapter card can be connected to the processor. The network adapter card is can be connected to a wide area network such as the Internet. A server can be connected to the Internet and adapted to receive data from the camera. The server stores multimedia data from the camera and sends the multimedia data to a remote viewer on demand. The camera captures a still image or a video, which can be captured based on one or more trigger conditions. A process sensor can be connected to the processor to capture process data in addition to camera data. A motor can be connected to the camera to pan the camera. A view port can be provided on the chamber. A light pipe can connect the camera to the view port. The light pipe can project from the outside of the process chamber to the inside of the chamber to allow the camera to capture the radiation illuminating the inside of the chamber. The camera can capture radiation illuminating outside the chamber. The radiation source is ambient radiation, an infrared light source coupled to the chamber, or a visible light source coupled to the chamber. An imaging processor can be connected to the camera to detect one or more predefined criteria. The imaging processor determines the position of one or more components in the chamber. The components include a wafer, a robot arm, a wafer cassette, a wafer support, or a chuck.

In another aspect, an apparatus captures one or more images of a semiconductor processing system with one or more transfer chambers and one or more process chambers. The apparatus includes a radiation source to generate radiation to illuminate the semiconductor processing system; and a camera coupled to the semiconductor processing system and adapted to receive the radiation reflected from the semiconductor processing system.

In yet another aspect, a system captures one or more images of a chamber with a radiation source to generate radiation to illuminate the chamber; a camera coupled to the process chamber and adapted to receive the radiation reflected from the chamber; a processor coupled to the camera; a data storage device coupled to the processor and the camera to store images from the camera; a network adapter card coupled to the processor and the Internet; a server coupled to the Internet and adapted to receive and store data from the camera, the server sending the multimedia data to a remote viewer on the Internet.

In another aspect, a method for viewing semiconductor processing operation includes illuminating a chamber with radiation; and capturing one or more views of the chamber using a camera.

Implementations of the above aspect may include one or more of the following. The method includes analyzing the views to locate the position of one or more components in the chamber. The components include a wafer, a robot arm, a wafer cassette, a wafer support, or a chuck. The method includes storing the views on a remote server. The method can also include streaming the views from the remote server to one or more remote viewers. The views can be captured based on the occurrence of one or more predetermined criteria. The criteria include a component movement, a component failure, an out-of-range condition, or predefined time interval.

Advantages of the system may include one or more of the following. The system allows one or more participants to view the operation of the processing chamber during the occurrence of specific conditions so that he or she can provide an accurate diagnosis of the problem. The participants can view the sequences regardless of their proximity to the system. Further, the system provides an online view of the process chamber that simulates the impact of an in-person maintenance meeting. The system enables participants to view operations on their desktop and have others view and optionally control the processing equipment. The system provides visualization of wafer movement and allows participants such as customers, vendors and suppliers working in different locations to come together in real time during the early problem stages to ensure accurate problem solving collaboration. Thus, globally disperse participants from suppliers and customers can collaborate and solve problems in real time. By getting online rather than on planes to collectively examine problems, maintenance teams can support products faster and cheaper than ever before. No longer will geographic boundaries hinder dispersed business partners from coming together to leverage each other's expertise. As the maintenance process becomes more efficient, product costs decrease and product quality increases.

The system achieves the above advantages while avoiding the introduction of external probes and equipment into the chamber. Thus, potential sources of particulate contamination in the chamber are reduced. Contamination is reduced since the substrate can be viewed in the isolation of the chamber. The system also minimizes the number of components in the chamber. The substrate viewing is provided in an apparatus that is simple to assemble, reliable and inexpensive.

Other features and advantages will become apparent from the following description, including the drawings and the claims.

### BRIEF DESCRIPTION OF THE DRAWINGS

FIG. 1 shows a cross sectional view of one embodiment of a system to monitor movements of a substrate or wafer in a processing chamber.

FIG. 2 shows a routine to take images or video sequences of a processing chamber using the camera.

FIG. 3 shows an exemplary process for viewing the sequences of images or videos captured using the camera.

FIG. 4 shows a routine to receive annotations from participants.

FIGS. 5-8 shows a plurality of camera configurations.

FIG. 9 shows a multi-chamber semiconductor processing system 800 with remote reviewing capability.

### DESCRIPTION

In the following description, the temperature of a substrate is discussed. The term “substrate” broadly covers any object that is being processed in a thermal processing chamber and the temperature of which is being measured during processing. The term “substrate” includes, for example, semiconductor wafers, flat panel displays, and glass plates or disks.

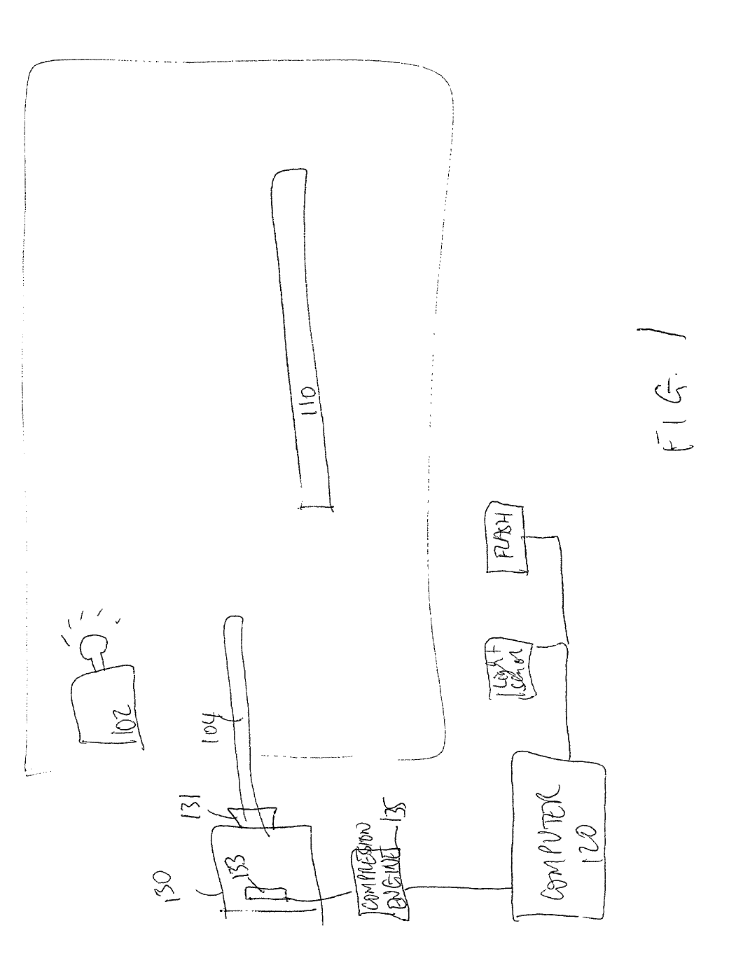

FIG. 1 shows a cross sectional view of one embodiment of a system 100 to monitor movements of a substrate or wafer 110. The wafer 110 may be any of a number of semiconductor materials such as silicon, silicon carbide, gallium arsenide, gallium nitride, for example. If desired, these semiconductor materials can be in combination with thin insulators and/or metal layers. The semiconductor wafer 110 is positioned in a reactor chamber (not shown) above a susceptor (not shown).

The system 100 includes a radiation source 102 that illuminates visible radiation such as light in one embodiment. Additionally, the source 102 can be a heat lamp including ultraviolet (UV) discharge lamps such as mercury discharge lamps, metal halide visible discharge lamps, or halogen infrared incandescent lamps, for example.

The visible radiation is beamed at one or more spots in the chamber. The reflected radiation (such as visible light) from the chamber is captured by a radiation guide 104. In one embodiment, the radiation guide 104 includes fiber optic cable bundles or light pipes to capture radiation from the radiation source 102 and transmit the sampled radiation to a camera.

In one embodiment, a motor 106 moves the radiation guide 104 to capture illuminated light from a particular section of the chamber. In another embodiment, the motor 105 “rocks” or oscillates the radiation guide 104 so that the guide 104 is swept back and forth over the chamber to capture full views of the chamber. The motor is controlled by a computer 120 using a suitable high voltage I/O motor controller board.

The guide 104 is connected to a video camera 130 to capture video or still images. The camera 130 includes a lens 131, an imaging element 133 that can be a charged coupled device (CCD) element, a JPEG or MPEG compression engine 135 to offload the data compression process from the processor 120 before providing the compressed data to a data storage device 137. The compression engine 135 can utilize wavelet technique and other techniques known to reduce data size. Alternative, if the computer 120 is sufficiently powerful, it can perform the compression function via a suitable compression software stored in the ROM or RAM. The CCD element 133 captures images associated with the pictures. The computer 120 also controls a number of camera settings through a shutter speed control unit that opens and closes for a predetermined time and a lens opening control unit that adjusts light levels to be received by the CCD element 133. Further, a lens-focusing unit is provided to automatically focus the images.

The output of the imaging element 133 is connected to an analog to digital converter whose output is provided to the computer 120. The computer 120 reads data from a distance sensor and adjusts the lens focusing unit until the lens reaches a position corresponding to the object distance data to perform the auto-focusing operation. The lens captures and directs light associated with the images to the CCD element 133. Further, the lens may be automatically switched with additional lens to provide zoom or panoramic view. Additionally, the lens have one or optional filters to filter lights coming to the lens. Also, a flash and light level sensor can be connected to the computer 120 to sense and provide corrective actions during the snapping of the picture. In the event that the light sensor detects a low light level, the processor 120 can take corrective actions, including changing the settings of the shutter speed control unit and the lens opening control unit. Additionally, the flash may be actuated, depending on the availability of light, to provide additional lighting.

In addition to capturing substrate movements, the computer 120 can monitor process parameters and provide a closed-loop temperature control with one or more substrate temperature sensors for sensing substrate temperature. The substrate temperature sensor can be a pyrometer, which is a non-contact temperature probe. The pyrometers are configured to measure substrate temperature. Additionally, contact probes (such as thermocouples) may be used to monitor substrate temperatures at low temperatures.

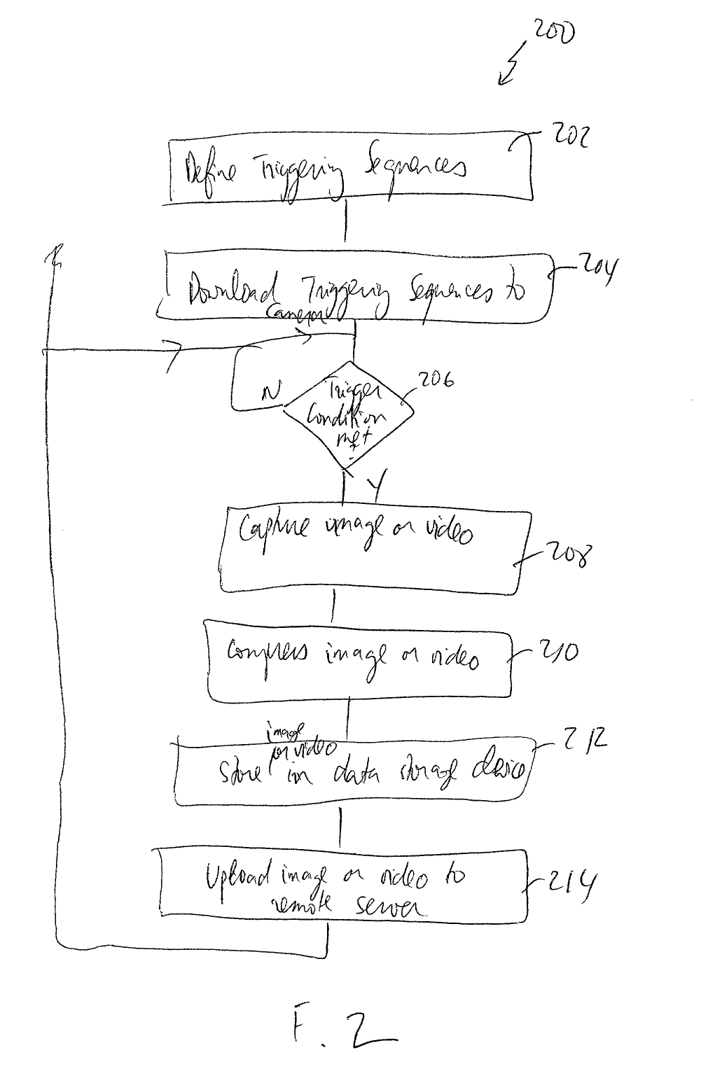

Turning now to FIG. 2, a routine 200 is shown to take images or video sequences of the chamber using the camera 130. First, the operator defines one or more triggering sequences (step 202). The triggering sequence is downloaded to the camera 130 and sensors are suitably set up to trigger the camera based on the triggering conditions (step 204). Next, the camera 130 enters an idle mode until one or more trigger conditions are met (step 206). Upon being triggered, the camera 130 takes a still image or a brief video of one or more portions of the chamber (step 208). The image or video is then compressed (step 210). The compression may be done as a JPEG compression for a still image or an MPEG compression for a video capture. The compressed image is then stored in the data storage device 137 (step 212). In one optional embodiment, the data stored by the data storage device 137 can uploaded to a central server over a wide area network such as the Internet (step 214). The camera 130 then loops back to step 204 to wait for the occurrence of the next trigger condition.

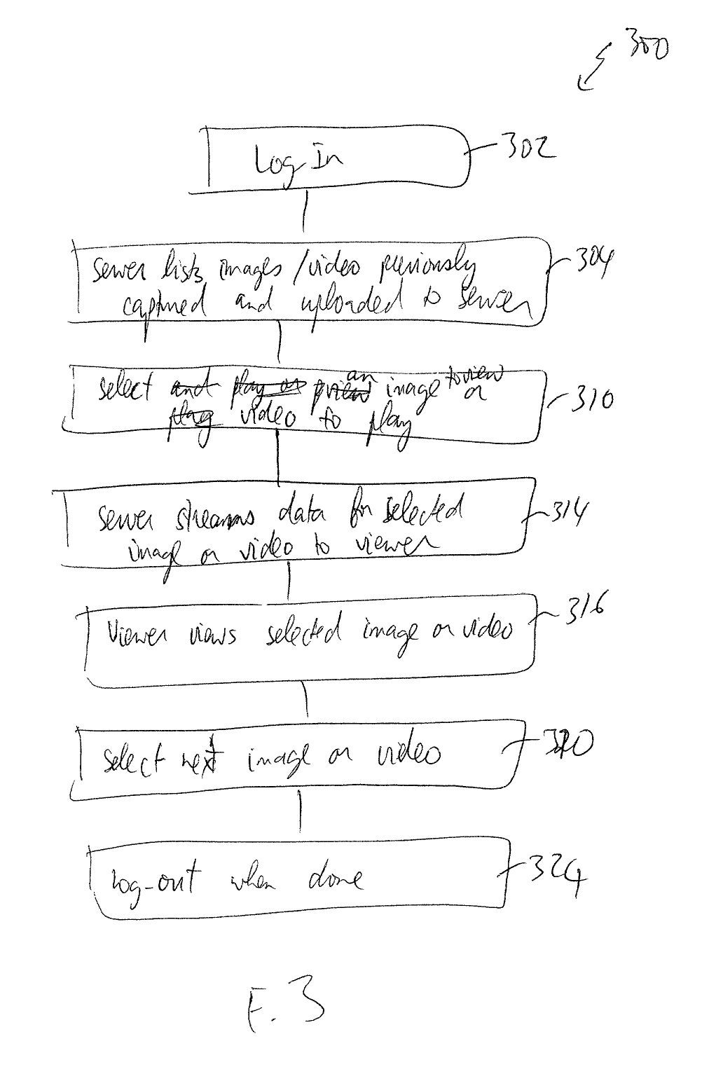

FIG. 3 shows an exemplary process 300 for viewing the sequences of images or videos captured using the camera 130. First, a participant logs into the computer 120, or in the case where the images and video are stored in the central server, the participant can log into the server (step 302). Upon a successful log-in, the server generates a list of images and/or video that have been taken (step 304). The participant can review a particular image or video, or can fast forward or reverse the images or video as desired (step 310).

Upon receipt of image or video selection choices from the participant, the server looks in its database and streams the images or video back to the participant over the Internet (step 314). The user then views the selected images or video (step 316) and can select the next image or video to view (step 320). When the user is done, he or she can log-out of the server (step 324).

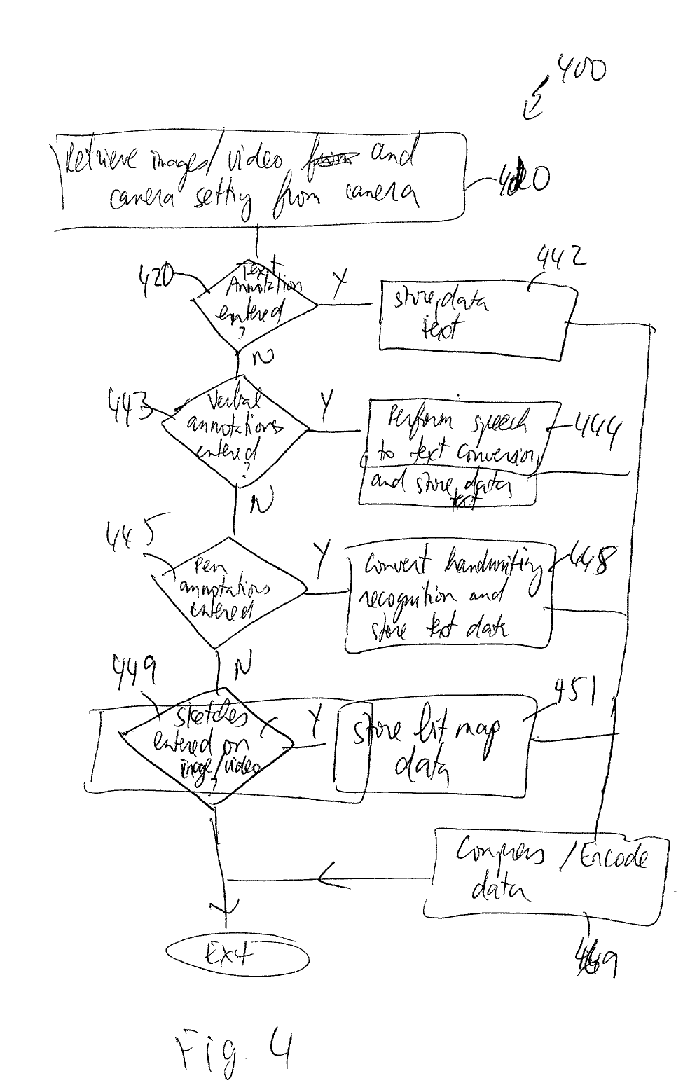

Turning now to FIG. 4, a routine 400 to receive annotations from participants is shown. In step 410, the routine retrieves the images/videos and the camera settings from the camera 130. Next, the routine determines if an annotation has been entered through the keypad or buttons/switches (step 420). If so, the routine stores the typed text data in step 442 before it proceeds to step 469 to encode the data. Alternatively, if data has not been entered via the keypad/switches, the routine checks if verbal annotations have been entered in step 443. If so, the routine performs a speech to text conversion in step 444 before proceeding to step 469.

Alternatively, from step 443, if no verbal annotations have been entered, the routine checks if pen annotations have been entered in step 445. If so, the routine proceeds to step 448 to convert the handwritten annotations into text using the hand recognition process discussed above. From step 448, the routine jumps to step 469 to format and encode the data. From step 445, if the handwritten annotations are not available, the routine checks for sketches as annotations. The annotations are then stored with the image or video file before the routine of FIG. 4 exits.

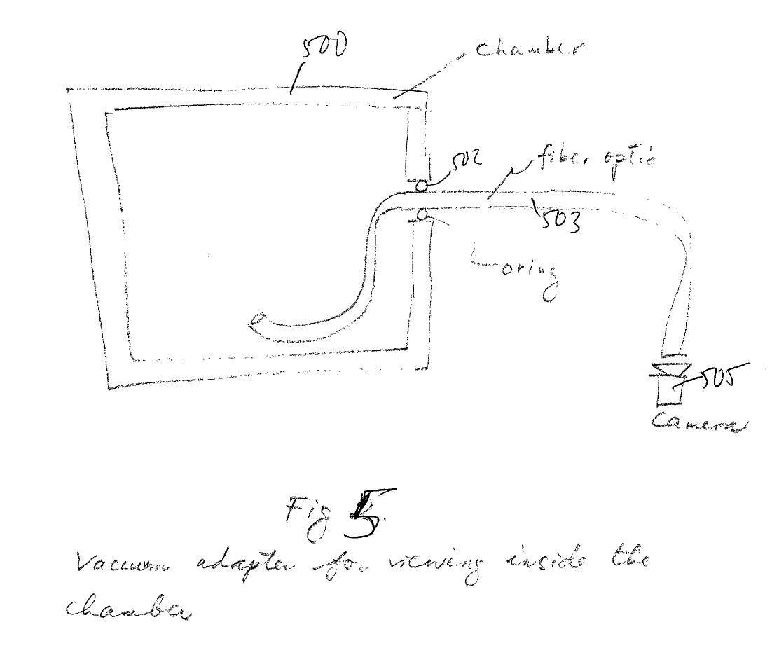

FIGS. 5-8 shows a plurality of camera configurations. In the configuration of FIG. 5, a chamber 500 has an opening through which a fiber optic cable 503 is inserted. An O-ring 502 is positioned at the opening to seal the chamber from the environment. The cable 503 is connected to a camera 505 so that the camera 505 can capture an image or a video of events in the chamber 500.

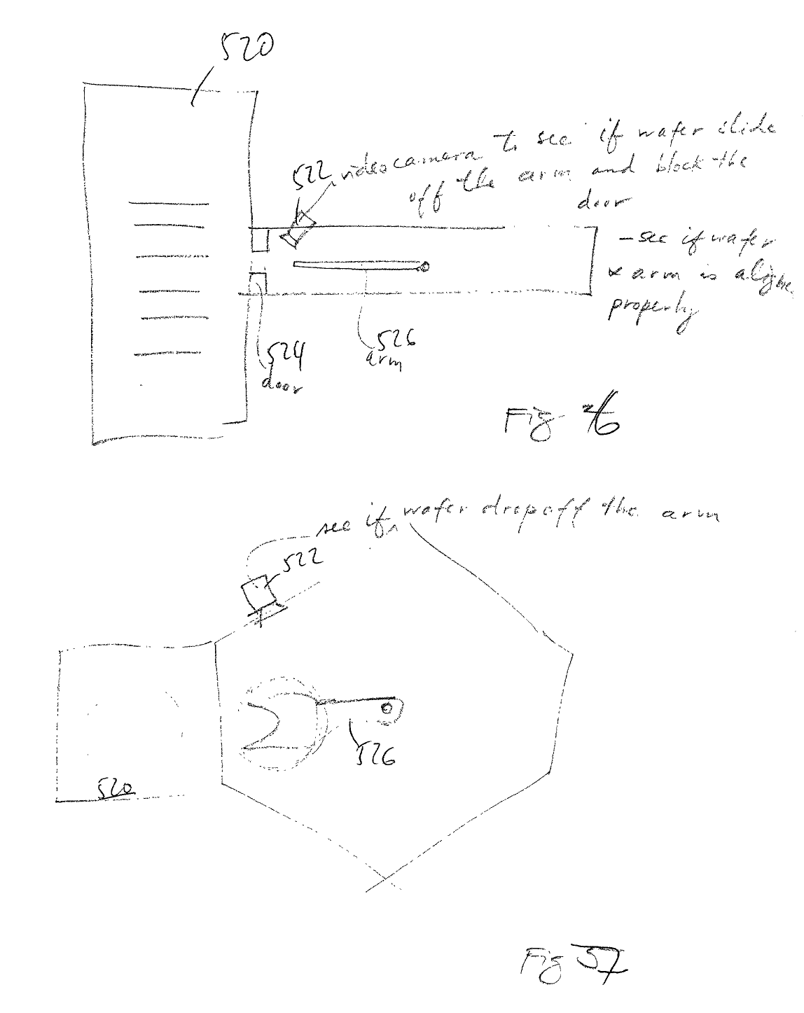

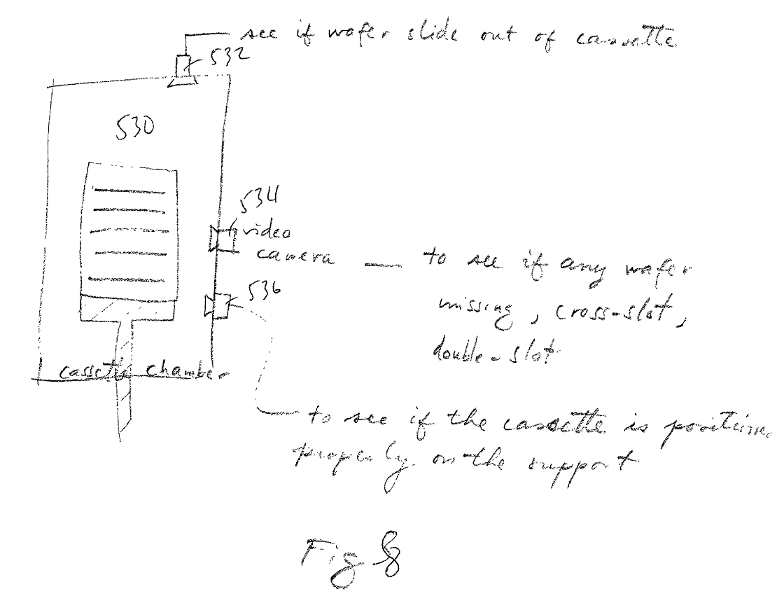

FIGS. 6-7 shows side and top views of a process chamber 520 and a camera system. In this embodiment, a camera 522 is positioned to observe wafer movement to check for alignment of a robot arm 522 and the wafer.

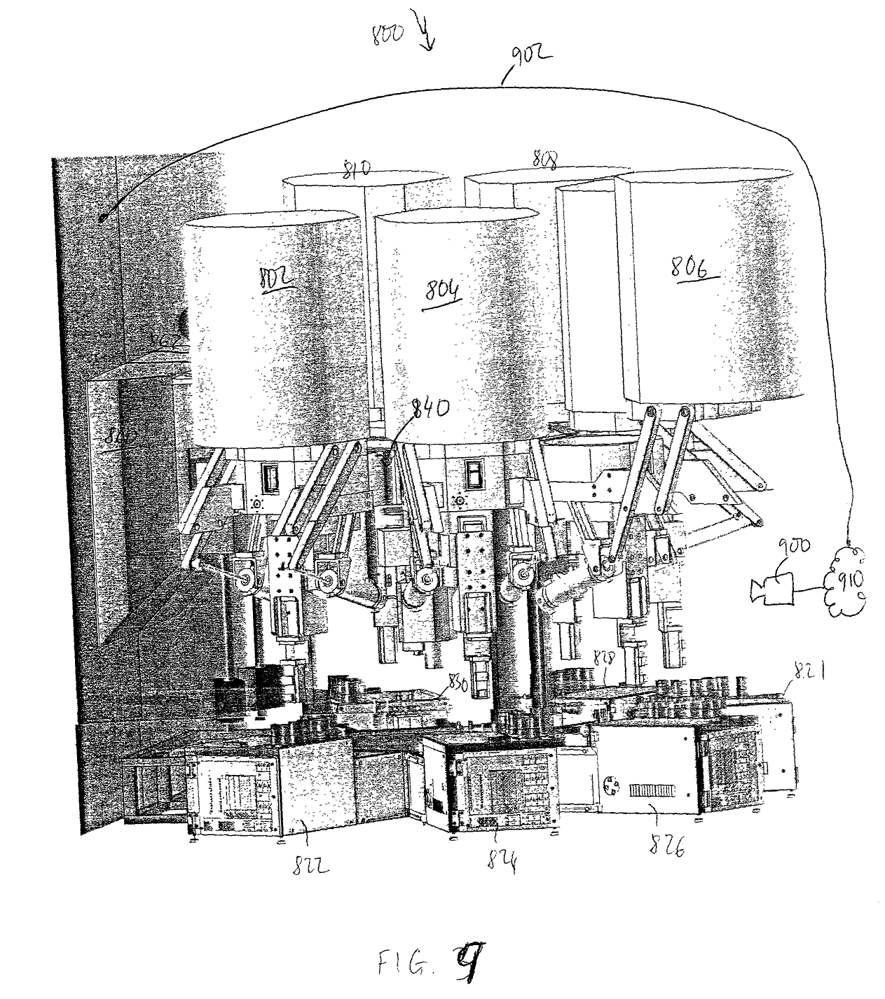

FIG. 8 shows yet another embodiment with a chamber 530 with a camera 532 mounted on top of the chamber 530. Two side cameras 534-536 are positioned to observe error conditions such as whether a wafer is missing or whether cross-slot or double-slot conditions exist. Also, the camera 536 detects whether a wafer cassette is properly positioned on a support unit.

Referring now to FIG. 9, a multi-chamber semiconductor processing system 800 with remote reviewing capability is shown. The processing system 800 has a plurality of chambers 802, 804, 806, 808 and 810 adapted to receive and process wafers 842. Controllers 822, 824, 826, 828 and 830 control each of the chambers 802, 804, 808 and 810, respectively. Additionally, a controller 821 controls another chamber, which is not shown for illustrative purposes.

Each of chambers 802-810 provides a lid 104 on the chamber body 102. During maintenance operations, the lid 104 can be actuated into the open position so that components inside the chamber body 102 can be readily accessed for cleaning or replacement as needed.

The chambers 802-810 are connected to a transfer chamber 840 that receives a wafer. The wafer rests on top of a robot blade or arm (not shown). The robot blade receives the wafer from an outside processing area.

The transport of wafers between processing areas entails passing the wafers through one or more doors separating the areas. The doors can be load lock chambers 860-862 for passing a wafer-containing container or wafer boat that can hold about twenty-five wafers in one embodiment. The wafers are transported in the container through the chamber from one area to another area. The load lock can also provide an air circulation and filtration system that effectively flushes the ambient air surrounding the wafers.

Each load lock chamber 860 or 862 is positioned between sealed openings, and provides the ability to transfer semiconductor wafers between fabrication areas. The load locks 860-862 can include an air circulation and filtration system that effectively flushes the ambient air surrounding the wafers. The air within each load lock chamber 860 or 862 can also be purged during wafer transfer operations, significantly reducing the number of airborne contaminants transferred from one fabrication area into the other. The load lock chambers 860-862 can also include pressure sensors that take air pressure measurements for control purposes.

During operation, a wafer cassette on a wafer boat is loaded at openings 850-852 in front of the system to a load lock through the load lock doors. The doors are closed, and the system is evacuated to a pressure as measured by the pressure sensors. A slit valve (not shown) is opened to allow the wafer to be transported from the load lock into the transfer chamber. The robot blade takes the wafer and delivers the wafer to an appropriate chamber. A second slit valve opens between the transfer chamber and process chamber, and wafer is brought inside the process chamber.

Containers thus remain within their respective fabrication areas during wafer transfer operations, and any contaminants clinging to containers are not transferred with the wafers from one fabrication area into the other. In addition, the air within the transfer chamber can be purged during wafer transfer operations, significantly reducing the number of airborne contaminants transferred from one fabrication area into the other. Thus during operation, the transfer chamber provides a high level of isolation between fabrication stations.

A camera 900 is provided to allow remote viewing of operations of the system of FIG. 9. Also, a fiber cable 902 is provided to allow viewing of chamber operations. The cable 902 is connected to another camera (not shown) inside the chamber. The image/video output from the fiber 902 and the camera 900 is digitized and transmitted over a wide area network 910 such as the Internet. The output can be compressed or encrypted as appropriate prior to transmission.

The control portion of the above system is implemented in a computer program executed on a programmable computer having a processor, a data storage system, volatile and non-volatile memory and/or storage elements, at least one input device and at least one output device.

Each computer program is tangibly stored in a machine-readable storage medium or device (e.g., program memory or magnetic disk) readable by a general or special purpose programmable computer, for configuring and controlling operation of a computer when the storage media or device is read by the computer to perform the processes described herein. The invention may also be considered to be embodied in a computer-readable storage medium, configured with a computer program, where the storage medium so configured causes a computer to operate in a specific and predefined manner to perform the functions described herein.

The present invention has been described in terms of several embodiments. The invention, however, is not limited to the embodiment depicted and described. For instance, the radiation source can be a radio frequency heater rather than a lamp. Hence, the scope of the invention is defined by the appended claims.

What is claimed is:

1. A system to capture one or more images of a semiconductor chamber, comprising:
a radiation source to generate radiation to illuminate the chamber; and
a camera coupled to the process chamber and adapted to receive the radiation reflected from the chamber.

2. The system of claim 1, wherein the radiation source comprises one or more lamps.

3. The system of claim 1, further comprising a processor coupled to the camera.

4. The system of claim 3, further comprising a data storage device coupled to the processor and the camera to store images from the camera.

5. The system of claim 3, further comprising a network adapter card coupled to the processor.

6. The system of claim 5, wherein the network adapter card is coupled to a wide area network.

7. The system of claim 5, wherein the network adapter card is coupled to the Internet.

8. The system of claim 7, further comprising a server coupled to the Internet and adapted to receive data from the camera.

9. The system of claim 1, wherein the server stores multimedia data from the camera and sends the multimedia data to a remote viewer on demand.

10. The system of claim 1, wherein the camera captures a still image or a video.

11. The system of claim 9, wherein the still image or video is captured based on one or more trigger conditions.

12. The system of claim 1, further comprising a process sensor coupled to the processor to capture process data in addition to camera data.

13. The system of claim 1, further comprising a motor coupled to the camera to pan the camera.

14. The system of claim 1, further comprising a view port coupled to the chamber.

15. The system of claim 14, further comprising a light pipe coupling to the camera to the view port.

16. The system of claim 1, further comprising a light pipe projecting from the outside of the process chamber to the inside of the chamber, the light pipe allowing the camera to capture the radiation illuminating the inside of the chamber.

17. The system of claim 1, wherein the camera captures radiation illuminating outside the chamber.

18. The system of claim 1, wherein the radiation source is ambient radiation.

19. The system of claim 1, wherein the radiation source is an infrared light source coupled to the chamber.

20. The system of claim 1, wherein the radiation source is a visible light source coupled to the chamber.

21. The system of claim 1, further comprising an imaging processor coupled to the camera to detect one or more predefined criteria.

22. The system of claim 21, wherein the imaging processor determines the position of one or more components in the chamber.

23. The system of claim 22, wherein the components include a wafer, a robot arm, a wafer cassette, a wafer support, or a chuck.

24. An apparatus to capture one or more images of a semiconductor processing system with one or more transfer chambers and one or more process chambers, the apparatus comprising:
a radiation source to generate radiation to illuminate the semiconductor processing system; and
a camera coupled to the semiconductor processing system and adapted to receive the radiation reflected from the semiconductor processing system.

25. A system to capture one or more images of a chamber, comprising:
a radiation source to generate radiation to illuminate the chamber; and
a camera coupled to the process chamber and adapted to receive the radiation reflected from the chamber;
a processor coupled to the camera;
a data storage device coupled to the processor and the camera to store images from the camera;
a network adapter card coupled to the processor and the Internet;
a server coupled to the Internet and adapted to receive and store data from the camera, the server sending the multimedia data to a remote viewer on the Internet.

26. A method for viewing semiconductor processing operation, comprising:
illuminating a chamber with radiation; and
capturing one or more views of the chamber using a camera.

27. The method of claim 26, further comprising analyzing the views to locate the position of one or more components in the chamber.

28. The method of claim 27, wherein the components include a wafer, a robot arm, a wafer cassette, a wafer support, or a chuck.

29. The method of claim 26, further comprising storing the views on a remote server.

30. The method of claim 29, further comprising streaming the views from the remote server to one or more remote viewers.

31. The method of claim 26, wherein the views are captured based on the occurrence of one or more predetermined criteria.

32. The method of claim 31, wherein the criteria include a component movement, a component failure, an out-of-range condition, or predefined time interval.

33. A method for remote viewing semiconductor processing operation, comprising:
illuminating a chamber with radiation;
capturing one or more views of the chamber using a camera;
storing the views on a remote server; and
streaming the views from the remote server to one or more remote viewers, wherein the views are captured based on the occurrence of one or more predetermined criteria.
